(19) United States
(12) Patent Application Publication
(10) Pub. No.: US 2016/0347935 A1
(43) Pub. Date: Dec. 1, 2016

(54) HOLLOW MOLDED OBJECT USING RESIN COMPOSITION FOR GAS ASSIST INJECTION MOLDING

(71) Applicant: SUMITOMO RIKO COMPANY LIMITED, Komaki-shi (JP)

(72) Inventors: Yuki Yabuya, Komaki-shi (JP); Koji Mizutani, Komaki-shi (JP)

(73) Assignee: SUMITOMO RIKO COMPANY LIMITED, Komaki-shi (JP)

(21) Appl. No.: 15/233,290

(22) Filed: Aug. 10, 2016

Related U.S. Application Data
(63) Continuation of application No. PCT/JP2015/077458, filed on Sep. 29, 2015.

(30) Foreign Application Priority Data
Sep. 30, 2014 (JP) 2014-200928

(51) Int. Cl. C08K 7/04; C08K 9/04; C08L 77/06; C08K 7/14; B29C 45/00; C08K 3/36

(52) U.S. Cl. CPC C08K 7/04; B29C 45/0001; B29C 45/0005; C08K 3/36; C08L 77/06; C08K 7/14; C08K 9/04; B29K 2077/00

(57) ABSTRACT

Provided is a resin composition for gas injection molding including polyamide resin, inorganic filler having a pH of 9 or more and an average particle diameter of 20 nm or less, and inorganic fibers having a number-average fiber length of from 50 μm to 400 μm. In addition, a pipe formed by subjecting the resin composition to gas injection molding has, in an inside thereof, a hollow continuous portion for a fluid flow path. Therefore, in the gas injection molding of the pipe using the resin composition, an inner peripheral surface of the pipe can be finished into a smooth flat surface, and even when a liquid having acidity is circulated in the hollow continuous portion of the pipe, the pipe can withstand the acidity.

### RELATED APPLICATION

This application is a continuation of International Application No. PCT/JP2015/77458, filed on Sep. 29, 2015, which claims priority to Japanese Patent Application No. 2014-200928, filed on Sep. 30, 2014, the entire contents of each of which are hereby incorporated by reference.

### TECHNICAL FIELD

The present disclosure relates to a resin composition for gas injection molding, a hollow molded object obtained using the resin composition, and a method of producing the hollow molded object, and more specifically, to gas injection molding of a hollow molded object using a fiber-reinforced thermoplastic resin as the resin composition.

### BACKGROUND ART

A part to be used, for example, in an engine room of an automobile is required to have properties such as strength under high-temperature and high-humidity conditions, water resistance, and heat resistance. As such a part, a part made of a metal has heretofore generally been used. In recent years, however, in response to a need for lightweighting, investigations have been made on automobile parts each using a fiber-reinforced resin (FRP) as an alternative to the metal. Of those, a glass fiber-reinforced thermoplastic resin (hereinafter abbreviated as “GFRP”), which is obtained by dispersing glass fibers in a thermoplastic resin, is excellent in versatility, processability, moldability, and the like, and is also excellent in terms of cost, and hence is used for replacement of the part made of a metal. A molded object of GFRP for an automobile is generally produced by melt-kneading and pelletizing a composition formed of a polyamide (PA) resin excellent in heat resistance and glass fibers, and remelting the pellets, followed by injection molding or the like (see Patent Literatures 1 and 2).

For example, as liquid conveying piping for a cooling liquid (water-based liquid) to be used in an engine cooling system (radiator) of an automobile, there have been used a pipe 1 as illustrated in a partial sectional view (cut model) of FIG. 1 and joints, e.g., an inlet, each of which is made of GFRP (hollow molded objects each having a hollow portion for a fluid flow path of a continuous shape). For molding of each of those hollow molded objects made of GFRP using the polyamide resin, in order to form a hollow inside in the molded object, there is used, of the above-mentioned injection molding methods, “gas injection molding” which involves injecting a high-pressure inert gas (Gas) into a molten molding material in a cavity of a molding die during injection molding to form a hollow portion (hollow continuous portion) in a molded article (see Patent Literature 3).

### RELATED ART DOCUMENT

### Patent Document

PTL 1: JP-A-2010-189637
PTL 2: JP-A-2012-025844
PTL 3: JP-A-2000-110837

### SUMMARY OF INVENTION

Now, a method of producing the above-mentioned hollow molded object having a hollow continuous portion, such as the pipe, is described with reference to FIG. 2, which is an illustration of a state immediately after molding. In FIG. 2, a pipe 1 is illustrated on the left side of the Cut Line represented by a dashed line, reference symbols 1e and 1e′ denote a gas injection end portion and a gas stopping end portion of a molding machine (not shown), respectively. When the pipe 1 is molded by a gas injection method, a gas (Gas) to be used for forming a molten resin composition (molding material) in a die of a molding machine into a hollow body is injected, for example, from a gas injection port 1h formed in the end portion 1e or the like into the molten resin composition. Then, as indicated by the outlined arrows, the gas presses the molten resin composition against the inner surface of the die (not shown) by the expansion pressure of the gas, and at the same time, expands the molten resin composition along the shape of the die (expansion by pressing) to form the inside space of the molded object including the pipe 1 into a predetermined continuous shape (fluid flow path) filled with the gas. Then, after cooling, the molded object [including the extra portions corresponding to the gas injection end portion and the gas stopping end portion of the molding machine (end portions 1e, 1e′)] is removed from the die, and those portions are cut at Cut Line in FIG. 2 to remove the extra portions. Thus, the pipe 1 as illustrated in FIG. 1 is obtained. The pipe 1 thus obtained seems to have no particular problem as a product even when subjected to an external appearance inspection or the like.

However, when a fluid was actually allowed to flow in some of the pipes 1, a problem occurred in that the flow rate of the fluid circulating the inside fluctuated. In view of this, the pipe was cut a long its longitudinal direction, and an inner peripheral surface 1b thereof was observed in detail. As a result, it was found that in a defective product, the inner peripheral surface 1b was not a flat uniform surface. Such “surface roughening” of the inner peripheral surface 1b occurs presumably because in contrast to an outer surface (outer peripheral surface 1a) which becomes flat by being pressed by gas pressure against an inner surface (cavity) of the die, the inner peripheral surface 1b is not subjected to such pressing, and hence the glass fibers in the resin composition float up to the inner peripheral surface 1b to form an uneven shape.

Particularly when the pipe 1 as described above is used as, for example, liquid conveying piping or an engine cooling system of an automobile, the surface roughening of the inner peripheral surface 1b causes piping resistance (pressure loss) due to friction in a fluid flowing in the pipe 1 or the like (hollow continuous portion), with the result that a sufficient flow rate cannot be kept.

In addition, in general, hollow molded objects made of a polyamide resin having formed in the inside thereof a flow path (hollow continuous portion) in which a water-based fluid is to be circulated, such as the liquid conveying piping of an engine cooling system, also have the following problem as their common problem: during the use of cooling water (LLC), the cooling water is deteriorated to have acidity, and the acid promotes hydrolysis of the polyamide resin, resulting in early deterioration of the product made of a polyamide resin, such as the pipe 1 or an inlet.

The embodiments has been made in order to simultaneously provide a resin composition for gas injection molding, which allows the inner surface of a hollow molded object to be finished into a smooth flat surface in gas injection molding, and which, even when a liquid having acidity is circulated, can withstand the acidity, a hollow molded object obtained using the same, and a method of producing the hollow molded object.

In order to achieve the above, according to a first aspect, there is provided a resin composition for gas injection molding, to be used for gas injection molding involving injecting a high-pressure gas into a molten resin composition in a cavity of a molding die to form, in at least part of the molten resin composition, a hollow portion filled with the gas, the resin composition including the following components (A) to (C):

(A) a polyamide resin;

(B) an inorganic filler having a pH of 9 or more and an average particle diameter of 20 nm or less; and

(C) inorganic fibers having a number-average fiber length of from 50 μm to 400 μm.

Further, according to a second aspect, there is provided a hollow molded object, including the resin composition for gas injection molding of the first aspect, the hollow molded object having, in an inside thereof, a hollow continuous portion for a fluid flow path formed by high-pressure gas injection in a molten state in a cavity of a molding die.

Further, according to a third aspect, there is provided a method of producing a hollow molded object, including: injecting the resin composition for gas injection molding of the first aspect in a molten state into a cavity of a molding die; and injecting a high-pressure gas into the cavity to perform gas injection molding of a hollow molded object having, in an inside thereof, a hollow continuous portion for a fluid flow path.

When, in gas injection molding, the fiber length of inorganic fibers, such as glass fibers, is set to a specific range, and an alkaline inorganic filler in the form of fine particles is used in combination therewith, the fine particles of the alkaline inorganic filler are aligned between the inorganic fibers and along the mold surface of an in injection molding mold during the gas injection molding to prevent the floating of the inorganic fibers, and the alkalinity neutralizes an acid to improve physical properties, such as inner surface flatness and hydrolysis resistance, required of, for example, liquid conveying piping of an engine cooling system of an automobile.

As described above, the resin composition for gas injection molding has blended therein (B) the inorganic filler having a pH of 9 or more and an average particle diameter of 20 nm or less in addition to (A) the polyamide resin and (C) the inorganic fibers having a number-average fiber length of from 50 μm to 400 μm. Accordingly, even in the gas injection molding, the inorganic filler having a small particle diameter is aligned in the inner surface of the hollow molded object to be obtained to cover unevenness of its surface due to the inorganic fibers, and thus the inner surface becomes a smooth flat surface. Therefore, the use of the resin composition for gas injection molding can provide a hollow molded object having less piping resistance (pressure loss) of the inner surface, which is suitable for, for example, liquid conveying piping of an engine cooling system of an automobile. In addition, the inorganic filler is alkaline with a pH of 9 or more, and hence even when cooling water or the like is deteriorated to have acidity, the acidity can be neutralized, and hydrolysis of the polyamide resin can be suppressed.

In addition, in the resin composition for gas injection molding, when at least one kind of polyamide resin selected from the group consisting of polyamide 66, polyamide 6T, and polyamide 610 is used as (A) the polyamide resin, the hydrolysis of the polyamide resin can be further suppressed while cost is suppressed.

Further, in the resin composition for gas injection molding, particularly when (B) the inorganic filler is silica, the hydrolysis of the polyamide resin can be further suppressed without an increase in cost because silica is inexpensive.

Further, in the resin composition for gas injection molding, particularly when the composition includes (D) a polyolefin resin, the water repellency of the entire resin is improved, and hence the hydrolysis of the polyamide resin can be further suppressed.

In addition, the hollow molded object having, in the inside thereof, the hollow continuous portion for a fluid flow path described in the second aspect can serve as a hollow molded object having less piping resistance (pressure loss) than that of a related-art product, thus being suitable for liquid conveying piping or the like. In addition, the alkaline inorganic filler neutralizes an acid, for example, in cooling water brought into proximity of the polyamide resin, and hence deterioration of the resin due to hydrolysis is suppressed. Therefore, the hollow molded object obtained by gas injection molding can be used as a long-life pipe made of a fiber-reinforced polyamide resin having appropriate performance as liquid conveying piping of an engine cooling system.

In addition, the method of producing a hollow molded object described in the third aspect enables efficient production of a hollow molded object having less piping resistance (pressure loss), thus being suitable for liquid conveying piping or the like as described above.

### BRIEF DESCRIPTION OF DRAWINGS

FIG. 1 is a partial cross-sectional view for illustrating the structure of a pipe made of a fiber-reinforced resin to be used in an engine cooling system of an automobile.

FIG. 2 is a partial cross-sectional view for illustrating a state immediately after molding of the pipe made of a fiber-reinforced resin to be used in an engine cooling system of an automobile.

### DESCRIPTION OF EMBODIMENTS

Now, embodiments of the present invention are described in detail.

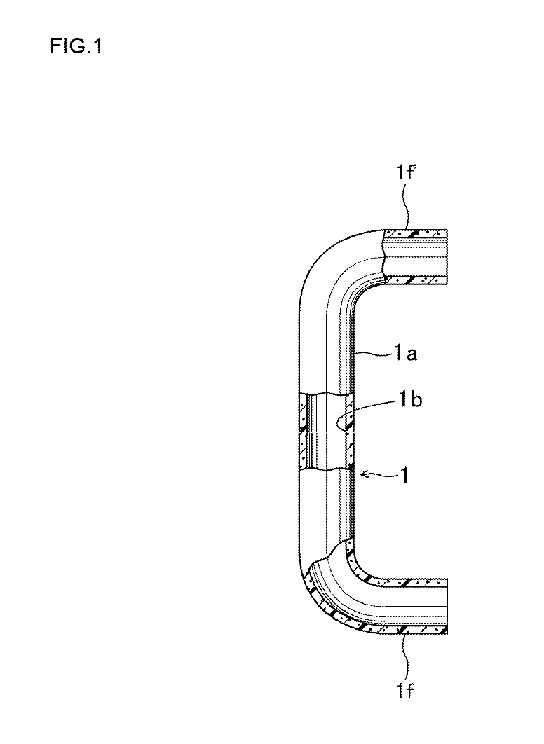

A resin composition for gas injection molding according to one embodiment is used for producing a hollow molded object (pipe 1 made of a fiber-reinforced resin, see FIG. 1) to be used in an engine cooling system of an automobile by a gas injection molding method involving injecting a high-pressure gas into a molten molding material (resin composition) injected into a cavity of a molding die. The resin composition contains the following components (A), (B), and (C), and the following optional components (D) and (E). component (A) Polyamide resin.
Component (B) Inorganic filler having a pH of 9 or more and an average particle diameter of 20 nm or less.
Component (C) Inorganic fibers having a number-average fiber length of from 50 μm to 400 μm.
Component (D) Polyolefin resin.
Component (E) Nigrosine.

Herein, the optional components (D) and (E) are optionally added in accordance with, for example, required performance of the hollow molded object and processing conditions of the gas injection molding.

By virtue of such blending, the resin composition for gas injection molding according to this embodiment can provide, even when the gas injection molding is used, a high-strength hollow molded object made of GFRP in which an inner surface (inner peripheral surface 1b) of the hollow molded object (pipe 1) is flat, and which withstands a high-temperature and high-humidity environment, for example, in an engine room of an automobile and has long life even when a liquid having acidity is circulated.

In addition, a hollow molded object according to one embodiment produced by the gas injection molding method is such that: a hollow continuous portion serving as a flow path for a liquid (cooling liquid) (fluid flow path) is formed inside the hollow molded object like the pipe 1 for liquid conveying of a cooling liquid illustrated in FIG. 1; and the surface (inner peripheral surface 1b) of the hollow continuous portion is a smooth flat surface having less piping resistance (pressure loss). Besides, as described above, the pipe 1 has long life because even when an acidic liquid (cooling liquid) is circulated in the hollow continuous portion (fluid flow path), deterioration due to the acid hardly occurs. Those are features of the hollow molded object of the one embodiment.

Next, each of the components constituting the resin composition for gas injection molding is described in detail.

### (A) Polyamide Resin

The resin serving as a main component constituting the resin composition for gas injection molding is a polyamide resin. In particular, in terms of strength in a high-temperature atmosphere, as a more suitable resin, there may be given polyamide 66, polyamide 6T, and polyamide 610. In addition, at least one kind of polyamide resin selected from the group consisting of polyamide 46, polyamide 6, polyamide 612, polyamide 11, polyamide 12, polyamide 92, polyamide 99, polyamide 912, polyamide 1010, polyamide 6I, polyamide 9T, polyamide 10T, polyamide 11T, polyamide MXD6, polyamide 6T/6I, polyamide 6/6I, polyamide 66/6T, and polyamide 66/6I may be used in addition to the three kinds of polyamide resins described above. Those polyamide resins are used in the form of, for example, any one of copolymers each containing the above-mentioned polyamide as a component, or a blend of two or more kinds of the copolymers or a blend of any of the copolymers and a homopolymer.

(B) Inorganic Filler having pH of 9 or more and Average Particle Diameter of 20 nm or less

Examples of the inorganic filler constituting the resin composition for gas injection molding may include, among silica, mica, talc, kaolin, calcium carbonate, potassium titanate, apatite, and the like, those satisfying a pH of 9 or more (alkaline) and an average particle diameter of 20 nm or less. Of those, from the viewpoints of processability (dispersibility), availability, and the like, silica is suitably used.

One kind of the above-mentioned inorganic fillers may be used alone, or two or more kinds thereof may be used in combination. In addition, the average particle diameter (particle diameter) of each of the various inorganic fillers is derived from a converted value based on a specific surface area value measured by a BET adsorption method.

Further, the “measurement of pH” of the inorganic filler may be performed as described below, for example, when silica is taken as an example. That is, first, 10 g of a sample (silica) is taken into a beaker, and 200 ml of distilled water is added, followed by stirring with a mixer so as to give a homogeneous suspension liquid. Next, while stirring is performed at such a low speed that a homogeneous suspension state can be maintained, a numerical value on a pH meter is read. Thus, the pH of silica (inorganic filler) may be measured (the same applies to other inorganic fillers). In addition, examples of the alkaline (basic) silica (component B) include colloidal silica and precipitated silica each having an average particle diameter of 2.0 nm or less. Specific examples of the colloidal silica include ST 30 (pH: from 9.5 to 10.5, particle diameter: from 10 nm to 20 nm) and ST-50 (pH: 9.0, particle diameter: from 20 nm to 30 nm) of the SNOWTEX series manufactured by Nissan Chemical Industries, Ltd. One kind of those silicas may be used alone, or two or more kinds thereof may be used in combination.

The content of (B) the inorganic filler in the resin

composition for gas injection molding falls within the range of from 0.1 part by weight to 30 parts by weight, preferably from 1 part by weight to 20 parts by weight, more preferably from 1.5 parts by weight to 10 parts by weight with respect to 100 parts by weight of (A) the polyamide resin. When the content of the inorganic filler is more than 30 parts by weight, moldability is liable to be reduced and the inner surface of the hollow molded object is liable to be roughened. In contrast, when the content is less than 0.1 part by weight, the “surface roughening” of the inner surface of the hollow molded object as pointed out above is liable to occur.

(C) Inorganic Fibers having Number-average Fiber Length of from 50 μm to 400 μm

As the inorganic fibers constituting the resin composition for gas injection molding, inorganic fibers having a number-average fiber length of from 50 μm to 400 μm among the following inorganic fibers may be used: amorphous fibers,, such as glass fibers, micro glass, rock wool, and ceramic fibers; polycrystalline fibers, such as carbon fibers, alumina fibers, and sepiolite; single crystal fibers, such as wollastonite and potassium titanate fibers; metal fibers; and the like. Of those, from the viewpoints of, for example, the strength of the molded object and cost, glass fibers are suitably used. In addition, the surfaces of the inorganic fibers may be subjected to acrylic surface treatment, urethane-based surface treatment, or the like. Of those, glass fibers having surfaces subjected to acrylic surface treatment are most suitable because their high affinity for the polyamide resin improves the strength of the molded object.

The “number-average fiber length” of the inorganic fibers was determined as described below. The hollow molded object was ashed at a temperature of from 500° C. to 700° C., and the resultant was homogeneously dispersed in water having a weight 1,000 or more times as large as the weight of the glass fibers after the ashing. Part of the homogeneous dispersion liquid was taken from the homogeneous dispersion liquid so that the weight of the glass fibers in the part fell within the range of from 0.1 mg to 2 mg, followed by filtration or drying to take a sample (mass of glass fibers) from the part of the homogeneous dispersion liquid. After that, images were randomly taken of the glass fibers contained in the sample with a microscope (manufactured by Keyence Corporation, VHW-1000) at a magnification of from 50 to 100 (the number of images, taken in the size of 89 mm by 127 mm, was from 3 to 5, and the total number of fibers observed was from 300 to 500), fiber lengths were measured for the total number of glass fibers included therein, and their average length was determined. Blur fibers (less than 0.05 mm) and fibers partially out of an image were excluded from the measurement.

In addition, the content of (C) the inorganic fibers in the resin composition for gas injection molding falls within the range of from 1 part by weight to 150 parts by weight, preferably from 3 parts by weight to 100 parts by weight, more preferably from 10 parts by weight to 90 parts by weight with respect to 100 parts by weight of (A) the polyamide resin. When the content of the inorganic fibers is more than 150 parts by weight, moldability is liable to be reduced and the inner surface of the hollow molded object is liable to be roughened. In contrast, when the content is less than 1 part by weight, the strength of the resultant hollow molded object is liable to be insufficient.

The resin composition for gas injection molding according to this embodiment having blended therein (C) the inorganic fibers as described above, in combination with (B) the inorganic filler, enables easy production of a high-strength hollow molded object in which the inner surface of the hollow molded object is smooth and which has long life even when used under a high-temperature and high-humidity environment.

(D) Polyolefin Resin and (E) Nigrosine

The resin composition for gas injection molding may contain (D) the polyolefin resin as an optional component. A typical example or the polyolefin resin is modified homopolypropylene (PP). The addition of such polyolefin resin to the composition improves the valor repellency of the surface of the hollow molded object, and thus can prevent cooling water (acidic water) from penetrating into the hollow molded object. A suitable content, of (D) the polyolefin resin in the resin composition falls within the range of from 1 part by weight to 100 parts by weight, more preferably from 5 parts by weight to 70 parts by weight with respect to 100 parts by weight, of (A) the polyamide resin.

In addition, the resin composition for gas injection molding may also contain (E) the nigrosine as an optional component. The nigrosine (black dye) is known to exhibit, through its addition to a resin composition, an action of decreasing a solidifying point as compared to the case of no addition (that is, “crystallization-retarding effect” which retards curing), and the action allows for a period of time required for a resin composition in a molten state to sufficiently expand in the cavity of the die by gas pressure. Therefore, moldability in the gas injection molding is improved, and as compared to the case of adding no nigrosine, the flatness and hydrolysis resistance of the inner surface are improved. A suitable content of (E) the nigrosine in the resin composition falls within the range of from 0.1 part, by weight to 5 parts by weight, more preferably from 0.5 part, by weight to 3 parts by weight with respect to 100 parts by weight of (A) the polyamide resin.

Specific examples of the nigrosine (black dye) include Solvent Black 5 (C.I. 50415, Cas No. 11099-03-9), Solvent Black 7 (C.I. 50415:1, Cas No. 8005-02-5/101357-15-7), and Acid Black 2 (C.I. 50420, Cas No. 8005-03-6/68510-98-5) based on color index.

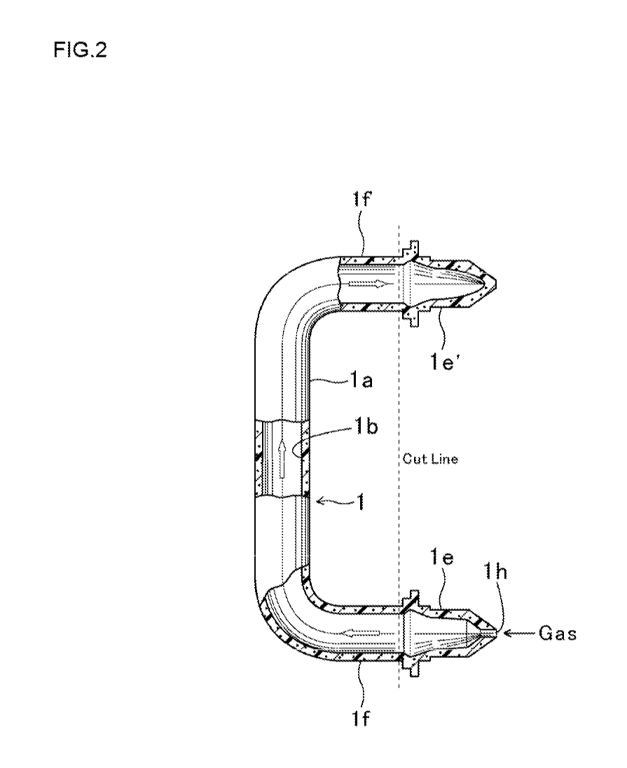

Next, a method of producing a pipe made of GFRP according to one embodiment is described with reference to FIG. 1 and FIG. 2.

The pipe 1 illustrated in FIG. 1 is produced, for example, as described below. That, is, a necessary amount of the resin composition for gas injection molding (sometimes referred to simply as “resin composition”) pelletized in advance is directly fed for each shot, into a gas assist injection molding machine, and a predetermined amount of a molten resin composition (molding material) is injected from a gas injection port 1h (see FIG. 2) or the like into a molding space (cavity) of a molding die.

Following the completion of the injection of the molten resin composition, as illustrated in FIG. 2, a high-pressure inert gas (nitrogen gas) is injected from the same gas injection port 1h, and as indicated by the outlined arrows in FIG. 2, the gas presses the molten resin composition present in the vicinity of the gas injection port 1h against the inner surface of the die (not shown) by the expansion pressure of the gas, and at the same time, expands the molten resin composition in a longitudinal direction along the shape of the cavity, to thereby form the inside space of the pipe 1 into a predetermined continuous shape (fluid flow path) filled with the gas.

Then, such state is kept for a while (pressure keeping), and then cooling is performed to stabilize the shape of the molded object, followed by the removal of the molded object from the die to provide a hollow molded object made of GFRP as illustrated in FIG. 2. The hollow molded object has, at the ends of the pipe 1 having a substantially channel shape, extra portions corresponding to a gas injection end portion and a gas stopping end portion of the molding machine (end portions 1e, 1e′).

Next, the hollow molded object is finished by cutting the extra end portions 1e, 1e′ at an intended cut line (dashed line “Cut Line” in FIG. 2) using a separately prepared cutter, cutting apparatus, or the like. Thus, the pipe 1 having a substantially channel shape (FIG. 1) suitable for liquid conveying piping to be used in an engine cooling system can be obtained. The molding material (resin composition) may be directly fed from a hopper or the like into the gas assist injection molding machine without being pelletized in advance.

In the gas injection molding using the resin composition according to this embodiment described above, the inner surface (inner peripheral surface 1b) of the hollow molded object (pipe 1) is finished into a smooth flat surface. Specifically, the average roughness Ra of the inner peripheral surface 1b becomes less than 30 μm. The average roughness Ra of the inner peripheral surface 1b is a value measured for the inner peripheral surface lb using a laser microscope (manufactured by Keyence Corporation, VK-X210) in conformity to “arithmetic average roughness” described in JIS B0601:1994 “Geometrical Product Specifications (GPS)-Surface texture: Profile method.” In addition, even without a measure such as molding into a large thickness, the hollow molded object is excellent in mechanical strength in a high-temperature atmosphere or at the time of water absorption, and sufficiently has strength required of a molded object having, in the inside thereof, a fluid flow path structure. Accordingly, the hollow molded object can also be used for, for example, joints, such as a radiator inlet and outlet. In addition, in the case of the use in an engine cooling system, even when cooling water or the like is deteriorated to have acidity, the hollow molded object withstands the acidity and has long life.

To the molding material for the hollow molded object (resin composition for gas injection molding), as necessary, a heat stabilizer, an antioxidant, a nucleating agent, a pigment, a weather-proofing material, a plasticizer, a lubricant, and the like may be appropriately added in addition to the components (A) to (C), and the optional components (D) and (E). One kind of those additives may be used alone, or two or more kinds thereof may be used in combination.

### EXAMPLES

Next, Examples are described together with Comparative Examples. However, the embodiment of the present invention is not limited, to these Examples without departing from, the gist of the present disclosure.

First, materials listed below were prepared prior to Examples and Comparative Examples.

[Polymer a]

Polyamide (PA) 66 pellet <manufactured by Asahi Kasei Corporation, LEONA 1402S>

[Polymer b]

Polyamide (PA) 6T pellet Manufactured by DuPont, ZYTEL FE8200BK>

[Polymer c]

Polyamide (PA) 610 pellet <manufactured by Toray Industries, Inc., AMILAN CM2006 >

[Polymer d]

Polypropylene (PP) pellet <manufactured by Sumitomo Chemical Company, Limited, NOBLEN WP638C>

[Inorganic Filler e]

Alkaline silica Manufactured by Nissan Chemical Industries, Ltd., ST-30, pH 10.5, particle diameter:: 10 nm>

[Inorganic Filler f]

Alkaline silica <manufactured by Nissan Chemical Industries, Ltd., ST-50, pH 9.5, particle diameter: 20 nm>

[Inorganic Filler g]

Alkaline silica <manufactured by AZ Electronic Materials, KLEBOSOL 30R25, pH 9, particle diameter: 25 nm>

[Inorganic Filler h]

Neutral silica <manufactured by AZ Electronic Materials, KLEBOSOL 1498V-9, pH 7, particle diameter: 10 nm>

[Inorganic Filler i]

Acidic silica <manufactured by Nissan Chemical Industries, Ltd., ST-O, pH 4, particle diameter: 10 nm>

The pH of each of the inorganic fillers was measured based on the method for the “measurement of pH” described above.

All of glass fibers described below are subjected to acrylic surface treatment. In addition, the average fiber length is determined by actually measuring glass fibers in the molded object after molding based on the method for the measurement of the “number-average fiber length” described above.

[Inorganic Fibers j]

Glass fibers Overage fiber length: 50 μm, fiber diameter: 17 μm>: glass roving of φ17 μm (manufactured by Nippon Electric Glass Co., Ltd., T-423N, elongated) which was cut at a fixed length of 1 mm.

[Inorganic Fibers k]

Glass fibers <manufactured by Nippon Electric Glass Co., Ltd., T-297, average fiber length: 200 μm, fiber diameter: 13 μm>

[Inorganic Fibers m]

Glass fibers <average fiber length: 400 μm, fiber diameter: 17 μm>: glass roving of φ17 μm (manufactured by Nippon Electric Glass Co., Ltd., T-423N, elongated) which was cut at a fixed length of 5 mm.

[Inorganic Fiber n]

Glass fibers <average fiber length: 600 μm, fiber diameter: 17 μm>: glass roving of φ17 μm (manufactured by Nippon Electric Glass Co., Ltd., T-423N, elongated) which was cut at a fixed length of 10 mm.

[Inorganic Fibers p]

Wollastonite <manufactured by Hayashi-kasei Co., Ltd., NYGLOS 4W, average fiber length: 25 μm, fiber diameter: 4.5 μm>

[Inorganic Fibers q]

Wollastonite <manufactured by Hayashi-kasei Co., Ltd., NYGLOS 8, average fiber length: 70 μm, fiber diameter: 8 μm>

<Molding of Hollow Molded Object>

The above-mentioned materials for resin compositions were blended at ratios shown in tables below. Then, in each of Examples 1 to 10, Examples 12 and 13, and Comparative Examples 1 to 5, a molding material (resin composition) which had been pelletized in advance was used to perform gas injection molding with a gas assist molding apparatus (gas assist injection molding machine). In addition, in each of Example 11 and Comparative Example 6, the molding material (resin composition) was not pelletized, and gas injection molding was performed by a method involving sequentially directly feeding the respective materials into a gas assist injection molding machine.

[Examples 1 to 10, Examples 12 and 13, and Comparative Examples 1 to 5]

### (1: Pelletization)

With the use of a twin-screw extruder, each resin, (polymers a to d) was fed from its primary supply port, and while melt-kneading (preset temperature: from 280° C. to 320° C., number of screw revolutions: from 100 rpm to 300 rpm) was performed, each inorganic fiber (j, k, p, q) and each inorganic filler (e to i) were sequentially fed from a side feed port and a secondary supply port along the way, respectively, at predetermined ratios. The extruded melt-kneaded product (resin composition) was drawn into a strand shape and cooled, and then cut with a pelletizer, followed by a drying step. Thus, polyamide resin composition pellets were obtained.

### (2: Gas Injection Molding)

The resultant polyamide resin composition pellets (molding material) were subjected to gas injection molding, using a gas assist molding apparatus under processing conditions to be described later, and both unnecessary end portions (dashed line “Cut Line” in FIG., 2) were cut off with a cutter or the like to produce a hollow molded object (pipe 1 having a substantially channel, shape of FIG. 1). The size of the resultant test piece is as follows: a tube shape having an inner diameter φ of 13 mm and an outer diameter φ of 19 mm [a resin thickness (thickness) of 3 mm], with a length along a straight tube (straight) portion of about 140 mm, and a width from the straight tube portion to a tube opening end (height) of about 60 nm.

[Example 11 and Comparative Example 6]

### (Gas Injection Molding)

A resin (polymer a), inorganic fibers (m, n), and an inorganic filler (e) which had been preblended were directly fed into a gas assist molding apparatus and subjected to gas injection molding under processing conditions to be described later, and unnecessary both end portions (dashed line “Cut Line” in FIG. 2) were cut off with a cutter or the like to produce a hollow molded object (pipe 1).

The processing conditions used in the gas injection

molding are as follows.

### <<Molding Conditions>>

Injection molding machine: manufactured by Toyo Seiki Seisaku-sho, Ltd., TM-280HW (φ968 mm)

Molding machine accessory, gas injector for hollow injection molding: manufactured by Asahi Kasei Engineering Corporation

Cylinder temperature: 310° C.±10° C.

Screw backing pressure: 5 MPa

Die temperature: 80° C.±20° C.

Injection speed: 39±5 cm/sec

Gas to be injected: nitrogen gas (gas pressure: 4.0 MPa, injection time: 15 seconds)

Pressure keeping time after gas injection: 40 seconds (80 MPa)

For the pipe 1 (test piece) of each of Examples and Comparative Examples obtained as described above, various properties were evaluated in accordance with criteria described below. The results of the evaluation are also shown in the tables below.

[Inner Surface Flatness]

In order to verify the flattening effect of the addition of a predetermined inorganic filler on the inner surface of a hollow molded object, a test piece was cut to expose its inner surface (hollow continuous portion serving as a flow path for a fluid: inner peripheral surface 1b), and an “average roughness Ra” (unit: μm) in conformity to “arithmetic average roughness” described in JIS B0601:1994 “Geometrical Product Specifications (GPS)-Surface texture: Profile method” was measured using a laser microscope (manufactured by Keyence Corporation, VK-X210). A smaller numerical value for the “average roughness Ra” indicates a more satisfactory state of the inner surface of the hollow molded object.

[Bending Strength] (Initial and After Water Immersion)

In order to verify the environmental durability of a hollow molded object based on the addition of a predetermined inorganic filler [degree of deterioration (hydrolysis) of a resin due to cooling water insertion], the strength of a bent site, “bending strength”, of the pipe 1 in a test piece was measured in each of an initial state after production and an aged state after water immersion. The bending strength was measured as follows: the straight tube portion at the center of the pipe 1 of FIG. 1 was fixed with a chuck or the like, and two loads of a first test and a second test were applied to each of both the end portions 1f, 1f′ each having a bent shape using a tensile load testing machine (manufactured by Shimadzu Corporation, Autograph AG-IS), and the average (unit: N) of the maximum loads (of the two tests) before the generation of damage to the surface of the curved portion or the like of the pipe 1 was determined. In addition, the test in the aged state after water immersion was performed by: immersing the test piece in simulated cooling water obtained by mixing water and LLC in equal amounts (1:1) under a 140° C. environment for 500 hours, and then applying the above-mentioned loads. The results of the tests are also shown in the tables below. A larger numerical value for the “bending strength” indicates more excellent water resistance.

TABLE 1

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| Blend- | Polyamide | a: PA66 | 70 | 70 | 70 | 70 | — | — | 40 | 50 | 50 | 80 |
| ing | resin | b: PA6T | — | — | — | — | 70 | — | — | — | — | — |
| (part(s) | | c: PA610 | — | — | — | — | — | 70 | — | — | — | — |
| by | Other | d: Polypropylene (PP) | — | — | — | — | — | — | 30 | — | — | — |
| weight) | resin | | | | | | | | | | | |
| | Inorganic | e: Alkaline silica (average | 0.1 | 2.5 | 5.0 | — | 2.5 | 2.5 | 2.5 | 2.5 | 2.5 | 2.5 |
| | filler | particle diameter: 10 nm) | | | | | | | | | | |
| | | f: Alkaline silica (average | — | — | — | 0.1 | — | — | — | — | — | — |
| | | particle diameter: 20 nm) | | | | | | | | | | |
| | | g: Alkaline silica (average | — | — | — | — | — | — | — | — | — | — |
| | | particle diameter: 25 nm) | | | | | | | | | | |
| | | h: Neutral silica (average | — | — | — | — | — | — | — | — | — | — |
| | | particle diameter 10 nm) | | | | | | | | | | |
| | | i: Acidic silica (average | — | — | — | — | — | — | — | — | — | — |
| | | particle diameter: 10 nm) | | | | | | | | | | |
| | Inorganic | j: Glass fibers (average | — | — | — | — | — | — | — | — | 50 | — |
| | fibers | fiber length: 50 μm) | | | | | | | | | | |
| | | k: Glass fibers (average | 30 | 30 | 30 | 30 | 30 | 30 | 30 | 50 | — | 20 |
| | | fiber length: 200 μm) | | | | | | | | | | |
| | | m: Glass fibers (average | — | — | — | — | — | — | — | — | — | — |
| | | fiber length: 400 μm) | | | | | | | | | | |
| | | n: Glass fibers (average | — | — | — | — | — | — | — | — | — | — |
| | | fiber length: 600 μm) | | | | | | | | | | |
| | | p: Wollastonite (average | — | — | — | — | — | — | — | — | — | — |
| | | fiber length: 25 μm) | | | | | | | | | | |
| | | q: Wollastonite (average | — | — | — | — | — | — | — | — | — | — |
| | | fiber length: 70 μm) | | | | | | | | | | |
| Proper- | Molding | Inner surface flatness | 22 | 18 | 17 | 23 | 18 | 18 | 18 | 25 | 24 | 15 |
| ties | processing | (surface roughness: Ra) μm | | | | | | | | | | |
| | property | | | | | | | | | | | |
| | Environ- | Bending strength (Initial) N | 4,560 | 4,550 | 4,500 | 4,530 | 5,300 | 4,100 | 3,600 | 5,750 | 5,700 | 4,300 |
| | mental | Bending strength (After | 650 | 750 | 700 | 630 | 3,800 | 2,300 | 800 | 1,200 | 800 | 400 |
| | durability | immersion) N | | | | | | | | | | |

TABLE 2

| | | | | | | Compar- | Compar- | Compar- | Compar- | Compar- | Compar- |
|---|---|---|---|---|---|---|---|---|---|---|---|
| | | | Exam- | Exam- | Exam- | ative | ative | ative | ative | ative | ative |
| | | | ple 11 | ple 12 | ple 13 | Example 1 | Example 2 | Example 3 | Example 4 | Example 5 | Example 6 |
| Blend- | Polyamide | a: PA66 | 70 | 70 | 70 | 70 | 70 | 70 | 70 | 50 | 80 |
| ing | resin | b: PA6T | — | — | — | — | — | — | — | — | — |
| (part(s) | | c: PA610 | — | — | — | — | — | — | — | — | — |
| by | Other | d: Polypropylene (PP) | — | — | — | — | — | — | — | — | — |
| weight) | resin | | | | | | | | | | |
| | Inorganic | e: Alkaline silica (average | 2.5 | 2.5 | 2.5 | — | — | — | — | — | 2.5 |
| | filler | particle diameter: 10 nm) | | | | | | | | | |
| | | f: Alkaline silica (average | — | — | — | — | — | — | — | — | — |
| | | particle diameter: 20 nm) | | | | | | | | | |
| | | g: Alkaline silica (average | — | — | — | — | 2.5 | — | — | — | — |
| | | particle diameter: 25 nm) | | | | | | | | | |
| | | h: Neutral silica (average | — | — | — | — | — | 2.5 | — | — | — |
| | | particle diameter 10 nm) | | | | | | | | | |
| | | i: Acidic silica (average | — | — | — | — | — | — | 2.5 | — | — |
| | | particle diameter: 10 nm) | | | | | | | | | |
| | Inorganic | j: Glass fibers (average | — | — | — | — | — | — | — | — | — |
| | fibers | fiber length: 50 μm) | | | | | | | | | |
| | | k: Glass fibers (average | — | 28.5 | 28.5 | 30 | 30 | 30 | 30 | 50 | — |
| | | fiber length: 200 μm) | | | | | | | | | |
| | | m: Glass fibers (average | 30 | — | — | — | — | — | — | — | — |
| | | fiber length: 400 μm) | | | | | | | | | |
| | | n: Glass fibers (average | — | — | — | — | — | — | — | — | 20 |
| | | fiber length: 600 μm) | | | | | | | | | |
| | | p: Wollastonite (average | — | 1.5 | — | — | — | — | — | — | — |
| | | fiber length: 25 μm) | | | | | | | | | |
| | | q: Wollastonite (average | — | — | 1.5 | — | — | — | — | — | — |
| | | fiber length: 70 μm) | | | | | | | | | |
| Proper- | Molding | Inner surface flatness | 25 | 17 | 17 | 30 | 33 | 18 | 18 | 40 | 32 |
| ties | processing | (surface roughness: Ra) μm | | | | | | | | | |
| | property | | | | | | | | | | |
| | Environ- | Bending strength (Initial) N | 4,570 | 4,300 | 4,325 | 4,600 | 4,000 | 4,550 | 4,550 | 5,800 | 4,350 |
| | mental | Bending strength (After | 760 | 800 | 850 | 350 | 400 | 330 | 330 | 900 | 400 |
| | durability | immersion) N | | | | | | | | | |

The following are found from the comparison of Examples and Comparative examples in the tables above. In the following description, “part by weight” represents the same value as the ratio of each component shown in the tables above, and “PHR” represents a value obtained by converting the ratio of each component into a ratio with respect to 100 parts by weight of the resin.

First, when attention is focused on the inorganic filler, the following are found.

Comparing Example 1 (e: alkaline silica (0.1 part by weight), 0.14 PHR), Example 2 (e: alkaline silica (2.5 parts by weight), 3.57 PHR), and Example 3 (e: alkaline silica (5.0 parts by weight), 7.14 PHR), it is found that as the addition amount of silica is increased, the inner surface flatness is improved.

Comparing Example 2 (e: alkaline silica having an average particle diameter of 10 nm (2.5 parts by weight), 3.57 PHR), Comparative Example 1 (no inorganic filler), Comparative Example 2 (g: alkaline silica having an average particle diameter of 25 nm (2.5 parts by weight), 3.57 PHR), Comparative Example 3 (h: neutral silica having an average particle diameter of 10 nm (2.5 parts by weight), 3.57 PHR), and Comparative Example 4 (i: acidic silica having an average particle diameter of 10 nm (2.5 parts by weight), 3.57 PHR), it is found that although the improving effect of the addition of silica on the inner surface flatness is comparable, in the case of using the alkaline silica whose an average particle diameter is 20 nm or shorter, the. degree of the redaction in bending strength after water immersion is small, indicating that the hydrolysis of the resin is suppressed,

Considering Example 2 (e: alkaline silica having an average, particle diameter of 10 nm (2.5 parts by weight), 3.57 PHR) and Comparative Example 2 (g: alkaline silica having an average particle diameter of 25 nm (2.5 parts by weight), 3.57 PHR), it is found that the addition of silica having a pH of 9 or more and an average particle diameter of from 5 nm to 20 nm or less improves the inner surface flatness.

In addition, when attention is focused on the kind of the resin in the tables above, the following are found.

Comparing Example 2 (polymer a: PA66), Example 5 (polymer b: PA6T), and Example 6 (polymer c: PA610), it is found that the inner surface flatness is satisfactory irrespective of the kind of the polymer, and in particular, the use of PA6T or PA610 greatly improves the bending strength after water immersion (hydrolysis resistance).

Comparing Example 2 (polymer a: PA66) and Example 7 (polymer a: PA66+polymer d: PP), it is found that the addition of the polyolefin resin (PP) improves the bending strength after water immersion (hydrolysis resistance).

Next, when attention is focused on the inorganic fibers in the tables above, the following are found.

Comparing Example 2 (k: glass fibers having an average fiber length of 200 μm (30 parts by weight), 42.9 PHR, e: alkaline silica (2.5 parts by weight), 3.57 PHR), Example 8 (k: glass fibers having an average fiber length of 200 μm (50 parts by weight), 100 PHR, e: alkaline silica (2.5 parts by weight), 3.57 PHR), Example 9 (j: glass fibers having an average fiber length of 50 μm (50 parts by weight), 100 PHR, e: alkaline silica (2.5 parts by weight), 3.57 PHR), and Comparative Example 5 (k: glass fibers having an average fiber length of 200 μm (50 parts by weight), 100 PHR, no inorganic filler), it is found that even when the addition ratio of the glass fibers is increased, the improving effect of the addition of silica on the inner surface flatness is kept.

Comparing Example 10 (k: glass fibers having an average fiber length of 200 μm (20 parts by weight), 25 PHR, e: alkaline silica (2.5 parts by weight), 3.57 PHR) and Comparative Example 6 (n: glass fibers having an average fiber length of 600 μm (20 parts by weight), 25 PHR, e: alkaline silica (2.5 parts by weight), 3.57 PHR), it is found that when the number-average fiber length of the inorganic fibers is more than 400 μm, the improving effect, of the addition of silica on the inner surface flatness is reduced.

Comparing Example 11 (m: glass fibers having an average fiber length of 400 μm (30 parts by weight), 42.9 PHR), Example 12 (part of k: glass fibers having an average fiber length of 200 μm is changed to p: wollastonite having an average fiber length of 25 μm (1.5 parts by weight), 2.14 PHR) , and Example 13 (part of k: glass fibers having an average fiber length of 200 μm is changed to q: wollastonite having an average fiber length of 70 μm (1.5 parts by weight), 2.14 PHR), it is found that when part of the inorganic fibers are replaced with inorganic fibers having a shorter average fiber length to form a mixed system, the inner surface flatness and the bending strength after water immersion (hydrolysis resistance) are improved.

Although specific embodiments of the present invention have been described in Examples above, Examples are for illustrative purposes only and are not to be construed as limitative. It is intended that various modifications apparent to a person skilled in the art fall within the scope of the embodiment of the present invention.

The resin composition for gas injection molding and the hollow molded object obtained using the same of the embodiments are such that the inner surface of the hollow molded object is finished into a smooth flat surface and the hollow molded object has long life even when used in the presence of an acidic liquid. Accordingly, the resin composition for gas injection molding and the hollow molded object obtained using the same of the embodiments can be suitably used for, for example, liquid conveying piping to be used around an engine cooling system for a vehicle, such as an automobile.

### REFERENCE SIGHS LIST

1 pipe
1a l outer peripheral surface
1b inner peripheral surface
1e, 1e′ end portion
1f, 1f′ end portion having bent shape
1h gas injection port

1. A hollow molded object comprising a resin composition for gas injection molding comprising the foil owing components (A) to (C):
(A) a polyamide resin;
(B) an inorganic filler having a pH of 9 or more and an average particle diameter of 20 nm or less; and
(C) inorganic fibers having a number-average fiber length of from 50 μm to 400 μm,
wherein the hollow molded object has,, in an inside thereof, a hollow continuous portion for a fluid flow path.

2. The hollow molded object according to claim 1, wherein (A) the polyamide resin, comprises at least one kind of polyamide resin selected from the group consisting of polyamide 66, polyamide 6T, and polyamide 610.

3. The hollow molded object according to claim 1, wherein (B) the inorganic filler comprises silica.

4. The hollow molded object according to claim 1, further comprising (D) a polyolefin resin.

5. The hollow molded object according to claim 1, wherein (B) the inorganic filler comprises at least one selected from the group consisting of silica, mica, talc, kaolin, calcium carbonate, potassium titanate, and apatite.

6. The hollow molded object according to claim 1, wherein the content of (B) the inorganic filler falls within the range of from 0.1 part by weight to 30 parts by weight, with respect to 100 parts by weight of (A) the polyamide resin.

7. The hollow molded object according to claim 1, wherein the content of (B) the inorganic filler falls within the range of from 1 part by weight to 20 parts by weight, with respect to 100 parts by weight of (A) the polyamide resin,

8. The hollow molded object according to claim 1, wherein (C) the inorganic fibers comprise at least one selected from the group consisting of amorphous fibers, polycrystalline fibers, single crystal fibers, and metal fibers,

9. The hollow molded object according to claim 1, wherein (C) the inorganic fibers comprise glass fibers.

10. The hollow molded object according to claim 1, wherein (C) the inorganic fibers have surfaces subjected to acrylic surface treatment or urethane-based surface treatment.

11. The hollow molded object according to claim 1, wherein the content of (C) the inorganic fibers falls within the range of from 1 part by weight to 150 parts by weight, with respect to 100 parts by weight of (A) the polyamide resin,

12. The hollow molded object according to claim 1, wherein the content of (C) the inorganic fibers falls within the range of from 3 parts by weight to 100 parts by weight, with respect to 100 parts by weight of (A) the polyamide resin.

13. The hollow molded object according to claim 4, wherein the content of (D) the polyolefin resin falls within the range of from 1 part by weight to 100 parts by weight, with respect to 100 parts by weight of (A) the polyamide resin.

14. The hollow molded object according to claim 1, further comprising (E) a nigrosine.

15. The hollow molded object, according to claim 16, wherein the content of (E) the nigrosine falls within the range of from 0.1 part by weight to 5 parts by weight, with respect to 100 parts by weight of (A) the polyamide resin.

16. The hollow molded object according to claim 1, wherein the average roughness Ra of an inner surface of the hollow molded object is less than 30 μm.

17. The hollow molded -object according to claim 1, wherein the hollow molded object is a liquid conveying pipe, a radiator inlet, or a radiator outlet.

18. The hollow molded object according to claim 1, wherein (C) the inorganic fibers comprise glass fibers and wollastonite.

19. The hollow molded object according to claim 1, wherein (A) the polyamide resin comprises polyamide 66.
